(19) United States
(12) Patent Application Publication
(10) Pub. No.: US 2018/0066157 A1
(43) Pub. Date: Mar. 8, 2018

(54) TWO-COMPONENT 100% NON-VOLATILE PAINT

(71) Applicant: Superior Finishes Inc., Winnipeg (CA)

(72) Inventors: Joseph Ernest Antoine Guertin, Winnipeg (CA); Karen Joy Pockett, Winnipeg (CA); Jean-Paul Edward Guertin, Winnipeg (CA); Pavlo Liebiediev, Winnipeg (CA)

(73) Assignee: Superior Finishes Inc., Winnipeg (CA)

(21) Appl. No.: 15/258,581

(22) Filed: Sep. 7, 2016

(51) Int. Cl. C09D 175/02; B05D 1/02; B05D 3/04

(52) U.S. Cl. CPC C09D 175/02; B05D 2503/00; B05D 3/0486; B05D 1/02

(57) ABSTRACT

A paint according to aspects of the present application has two components that form a solid material when mixed. A lack of Volatile Organic Compounds assist in distinguishing paint according to aspects of the present application from many existing paints. By controlling humidity in the spray (application) booth or in a separate curing booth, the time to cure the coating may be correspondingly controlled. That is, the higher the Relative Humidity, the faster the cure. When heat is introduced along with humidity, the time to cure the coating may be further controlled.

### FIELD

The present application relates generally to paints and, more specifically, to a two-component, 100% non-volatile paint.

### BACKGROUND

Original Equipment Manufacturers (OEMs) may be considered to be companies that manufacture their products on manufacturing and assembly lines. OEMs often coat their products with paint. The paint with which the OEMs coat a particular product may take one of a variety of forms. There are solvent-based paints, water-based paints and paints in the form of a powder coating, among other forms. One option for drying a freshly painted product is air drying. Another option for drying a freshly painted product is “force” drying, which is often carried out at temperatures between 140° F. and 280° F. for a duration of about 20 minutes. A further option for drying a freshly painted product is to bake the product at temperatures between 290° F. and 450° F. for a duration between 10 minutes and 90 minutes.

### BRIEF DESCRIPTION OF THE DRAWINGS

Reference will now be made, by way of example, to the accompanying drawings which show example implementations; and in which:

FIG. 1 schematically illustrates an example conveyor system;

FIG. 2 illustrates a chart providing example relative quantities for ingredients of a Component of a paint according to an aspect of the present application;

FIG. 3 illustrates example steps in a method of using a paint according to aspects of the present application; and

FIG. 4 illustrates a plot relating Print-free time to temperature for experiments carried out on a paint according to aspects of the present application.

### DETAILED DESCRIPTION

A two-component, 100% non-volatile paint may be used in place of a water-based paint, a solvent-based paint or a powder coating paint.

According to an aspect of the present disclosure, there is provided a paint formed by mixing a first component with a second component. The first component includes an amine-functional aspartic acid ester, an cycloaliphatic diamine, propylene carbonate and a molecular sieve. The second component includes an hexamethylene diisocyanate trimer polyisocyante.

According to a further aspect of the present disclosure, there is provided a method of forming a paint comprising mixing a first component with a second component. The first component includes an amine-functional aspartic acid ester, an cycloaliphatic diamine, propylene carbonate and a molecular sieve. The second component includes a hexamethylene diisocyanate trimer polyisocyante.

According to another aspect of the present disclosure, there is provided a method of painting an object. The method includes mixing a first component with a second component to form a paint, controlling a humidity in a spray chamber while applying the paint to the object in the spray chamber and controlling a humidity in a curing chamber while allowing the paint to cure on the object in the curing chamber. The first component includes an amine-functional aspartic acid ester, an cycloaliphatic diamine, propylene carbonate and a molecular sieve. The second component includes a hexamethylene diisocyanate trimer polyisocyante.

Other aspects and features of the present disclosure will become apparent to those of ordinary skill in the art upon review of the following description of specific implementations of the disclosure in conjunction with the accompanying figures.

It is expected that, for a particular OEM, elements of a product may be conveyed such that the elements arrive at a paint department. The conveying of the elements may, for one example, occur through the use of an overhead conveyor system or may, for another example, occur along a floor-based conveyor system.

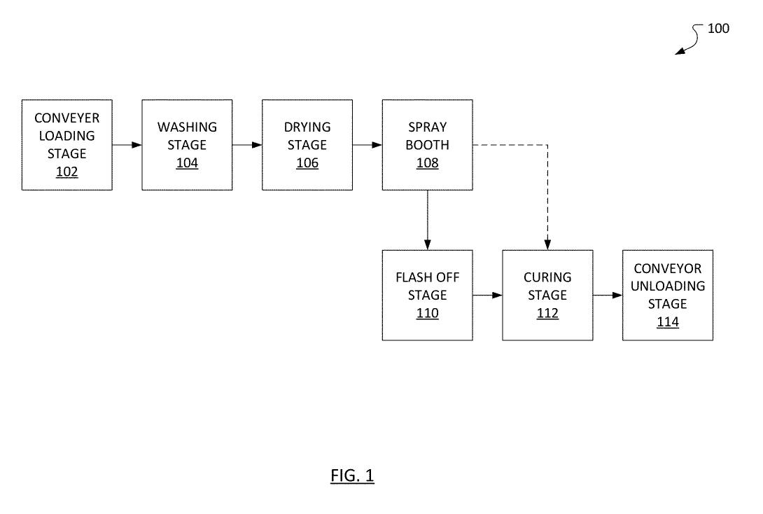

An example conveyor system 100 is schematically illustrated in FIG. 1. The example conveyor system 100 may include a conveyor loading stage 102, at which an item may be loaded onto the conveyor. Upon loading, the item may be conveyed through a washing stage 104, at which the item may be washed. In some cases, the item is subject to a five stage wash. Subsequent to the washing stage 104, the item may be conveyed through a drying stage 106, at which an item may be dried. Subsequent to the drying stage 106, and upon arriving at the paint department, the item may be conveyed through a spray booth 108 (also called a spray chamber). In one example, while being conveyed through the spray booth 108, the item stops in the spray booth 108. In another example, the item continuously moves through the spray booth 108 while being painted. Subsequent to the spray booth 108, the item may be conveyed through a flash off stage 110. In the flash off stage 110, solvent or water (or both solvent and water) evaporate out of the painted film. Subsequent to the flash off stage 110, the item may be conveyed a curing stage 112. The curing stage 112 may involve a curing oven. Subsequent to the curing stage 112, the item may be conveyed a conveyor unloading stage 114. In the case wherein the paint is a powder coating, the item may be passed directly from the spray booth 108 through the curing stage 112.

In one example, while being painted, the product is in a state wherein the product comprises a set of unassembled elements. This state is known as “knocked down.” In another example, while being painted, the product has been assembled, at least in part.

In overview, a paint according to aspects of the present application has two components that form a solid material when mixed. A lack of Volatile Organic Compounds assist in distinguishing paint according to aspects of the present application from many existing paints. By controlling humidity in the spray booth 108 or in the curing stage 112, the time to cure the coating may be correspondingly controlled. That is, the higher the Relative Humidity, the faster the cure. When heat is introduced along with humidity, the time to cure the coating may be further controlled.

A paint according to aspects of the present application is prepared by mixing two components. The two components are referenced hereinafter as Component A and Component B.

A paint according to aspects of the present application may be prepared using components defined by the following example recipes. These example recipes are presented to demonstrate general principles associated with the present application. As will be clear to a person of ordinary skill in the art, the recipes should not be considered limiting.

The first component, Component A, may be formed to include: an amine-functional aspartic acid ester; an cycloaliphatic diamine; propylene carbonate; an ultra-violet light absorber of the hydroxyphenylbenzotriazole class; hydrofunctional oxazolidine; a micronised amide wax rheology modifier; and Titanium dioxide.

The amine-functional aspartic acid ester may be, for example, DESMOPHEN® NH 1420, which is commercially available from Covestro of Leverkusen, Germany.

The cycloaliphatic diamine may be VESTAMIN A 139, for example, which is commercially available from Evonik Industries of Essen, Germany.

The propylene carbonate may be, for example, JEFFSOL® PC, which is commercially available from Huntsman Corporation of The Woodlands, Tex.

The dispersing agent may be, for example, DISPERBYK-2155, which is commercially available from BYK Additives & Instruments GmbH of Wesel, Germany.

The molecular sieve may be, for example, SYLOSIV® 3A, which is commercially available from W. R. Grace & Co.-Conn. of Columbia, Md.

The ultra-violet light absorber of the hydroxyphenylbenzotriazole class may be, for example, Tinuvin® 292, which is commercially available from BASF of Ludwigshafen, Germany.

The hydrofunctional mono-oxazolidine may be, for example, Incozol® 2, which is commercially available from Incorez of Preston, England.

The micronised amide wax rheology modifier may be, for example, CRAYVALLAC® SUPER, which is commercially available from Arkema of Colombes, France.

The Titanium dioxide may be, for example, TRONOX® CR-826, which is commercially available from Tronox Corporation of Stamford, Conn.

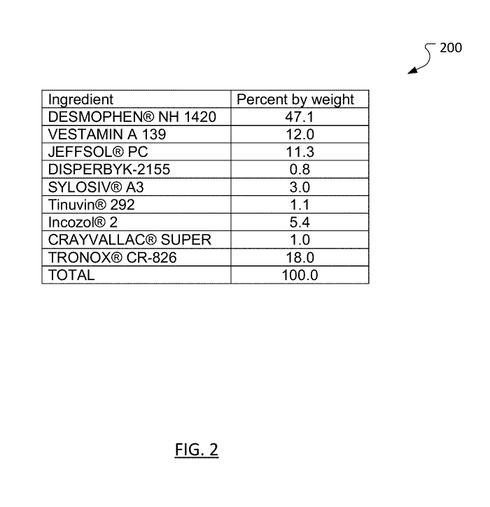

A chart 200, presented in FIG. 2, provides example relative quantities for the ingredients of Component A.

The second component, Component B, may be formed to comprise a hexamethylene diisocyanate (HDI) trimer polyisocyante, such as Desmodur® N 3900, which is commercially available from Covestro of Leverkusen, Germany.

It proposed herein that a two-component, 100% non-volatile paint be formed by combining the above-described Component A with the above-described Component B. In one aspect of the present application, the two-component, 100% non-volatile paint be formed using 54.2 g of Component B for every 100 g of Component A. That is, the paint according to this one aspect of the present application is formed using a rough ratio of Component A to Component B of 65:35.

The paint resulting from mixing Component A with Component B may be shown to have a viscosity of less than 120 Kreb units (KU) at 20° C.

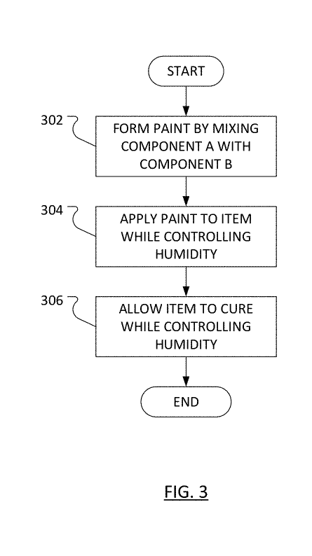

Example steps in a painting method using a paint according to aspects of the present application are illustrated in FIG. 3. Initially, the paint is formed (step 302) by mixing Component A and Component B. Subsequently, the paint is applied (step 304) to an item that is to be painted. While the paint is applied (step 304), humidity in the spray booth 108 is controlled. The item is then allowed (step 306) to cure. While the paint is allowed (step 306) to cure, humidity in the curing stage 112 is controlled.

Often, for known paints, including those formed of multiple components, there is a need to heat up either one or both components or the mixed paint to lower the viscosity for improved sprayability.

Conveniently, in aspects of the present application, there is no need to heat up either component A, component B or the mixed paint to lower the viscosity for sprayability. The paint according to aspects of the present application can be heated to 140° F. to drop the viscosity to ≈65 KU. Conveniently, there is no need to use an proportioning unit, such as a Gusmer model H-20/35.

It may be shown that a coating of paint according to aspects of the present application at 4 mils dry on “near white SSPC SP-10 Blast cleaning of metal” will pass 1000 hours of salt spray when used direct to metal, ASTM B117.

The Component A, or “pigmented side” of the paint, cures with an Isocyanate, such as an HDI Trimer (the Component B). The HDI Trimer may be under indexed by 10% and over indexed by as much as 40%, depending upon humidity, and still maintain a dry time for the paint that is acceptable to a manufacturer employing the paint.

The Component A, or “pigmented side” of the paint according to aspects of the present application, may be shown to have a pot life (usable viscosity), after mixing, that is no more than 120 Kreb units at 20° C. in 10 minutes to 2 hours.

To protect it from moisture, the Component A may be kept under a nitrogen blanket or may be kept in a descant bottle.

To protect it from moisture, the Component B may be kept under a nitrogen blanket or may be kept in a descant bottle.

A large object may be defined as an object for which time to spray paint is estimated at longer than 10 minutes. When painting a large object with a paint formulated according to aspects of the present application, it is proposed herein to control humidity. For example, humidity may be controlled so as not to exceed 30% relative humidity. In this example, temperature may range from 15° C. to 40° C.

Paints formed according to aspects of the present application are intended to be used on any metal, concrete, plastic and wood to be used indoors and outdoors. Examples products suitable for painting with paint formulated in accordance with aspects of the present application include: farm machinery; transformers; hydraulic cylinders that have heat sensitive seals; heavy equipment; trailers; rail cars; decks; truck boxes; wind turbines; Medium-Density Fiberboard (MDF); windows; and doors.

Known polyurea coatings, formed from recipes developed in the 1990s, may be shown to have gel times of 1 to 20 seconds. The markets for polyurea coatings included roof coatings, secondary containment, truck bed liners, car park decks, bridges, offshore tank coatings, etc. The basic coating contained: isocyanate; reactive diluents; polyether amines; chain extenders; additives; and pigments.

Such polyurea coatings gained popularity in floor coatings and spray applied coatings. To spray these known polyurea coatings, the polyurea coatings had to be blended with solvents that lengthened the pot life and gave viscosities that were manageable.

Without the use of solvents, the pot life was shortened considerably and the polyurea had to be heated to as much as 140° F. and atomized between 2,000 and 3,000 PSI. This would give an orange peel surface at 20+ mils in film thickness.

An example of the evolving technology is Envirolastic® PA Polyaspartic marketed by Sherwin-Williams of Cleveland, Ohio Envirolastic® is a 100% non-volatile, spray-applied aliphatic polyaspartic polyurea that exhibits excellent color retention, gloss and UV stability. Envirolastic® can be applied at thicknesses of 8-12 mils in a single pass on horizontal surfaces or multiple passes on vertical surfaces.

In the Sherwin-Williams literature for Protective+Marine Coatings, the Application Equipment lists fluid pressure of 1,800 psi and recommends heating the hose that carries the paint to 140° F. Gel time: 20 minutes, Tack free: 60 minutes, Foot traffic: 2 hours, to cure: 24 hours.” The Sherwin-Williams literature further states “Relative humidity: 80% maximum.” Gel time: 20 minutes.

The Applicant has identified the 20 minute gel time as problematic.

In contrast, it may be shown that a paint formulated according to aspects of the present application can achieve a delay of 120 minutes, or longer, before gelling.

This delay may be shown to better allow for “hot boxing.” The term “hot boxing” refers to mixing Component A with Component B and then running the resulting paint through a single component pump system to spray the resulting paint onto an object. The delay further provides time to flush the single component pump system before the resulting paint gels.

The long pot life also allows the paint to be run through two component, multi ratio systems, such as known PROMIX® systems marketed by Graco Inc. of Minneapolis, Minn. In the PROMIX® PD2K Component Proportioner, a mixing chamber can be attached to a painter's hip belt. Conveniently, the placement of the mixing chamber at the painter's hip helps to reduce flushing costs.

There currently exists 100% non-volatile paint products for which production involves mixing a first component with a second component. It is typical, for these paint products, that the first component is selected so that the viscosity of the first component is very close to the viscosity of the second component, thereby facilitating homogeneous mixing. The viscosity of the first component may be considered “very close” to the viscosity of the second component when the viscosity of the first component and the viscosity of the second component are both in a range defined, at a low end, by about 4,500 centipoise and defined, at a high end, of about 6,000 centipoise.

These known 100% non-volatile paint products often have a viscosity of more than 6,000 centipoise (cP) when mixed. These known products also are typically associated with instructions that recommend heating the first component and the second component, perhaps to distinct temperatures, to, thereby, further equalize the component's respective viscosities. Subsequently, the mixed product is often maintained at a standard level of heat to maintain a relatively low viscosity for the mixed product. For heated paint products such as these, spraying is typically accomplished using a pressure of around 1,800 psi.

One recommended spray gun for polyaspartic polyurea is the GX-8 marketed by Graco Inc. of Minneapolis, Minn. Conveniently, the GX-8 spray gun has direct impingement mixing. The GX-8 spray gun is designed for very low output, fast-set polyurea, polyurethane and hybrid coatings. The GX-8 spray gun is designed to save on material consumption by significantly reducing overspray associated with low-output spraying.

Currently airless spray equipment having a nozzle of 15 thou at a pressure of 1,450 psi has a rough delivery rate of 0.21 gallon per minute.

Due to relatively low viscosity, a paint formulated according to aspects of the present application is able to be applied through most existing equipment. The invention may be heated up to 140° F. for a finer spray pattern but such heating is not a necessity.

Set time may be defined as the time required by a paint to set up, or gel, after being sprayed.

A paint formulated according to aspects of the present application has a controllable set time.

The set time of existing polyurea polyaspartic paints is typically not very controllable. The set time for existing polyurea polyaspartic paints is normally between 5 seconds and 20 minutes.

The relatively fast set time of existing polyurea polyaspartic paints can make it difficult to paint large single items. For example, a large single item may require an hour to paint. It is anticipated that, in an attempt to paint such a large single item with an existing polyurea polyaspartic paint having a relatively fast set time, there would be a significant amount of dry overspray.

In a controlled-humidity spray chamber, the set time for a paint formulated according to aspects of the present application may be controlled. When painting a relatively large object, in a controlled-humidity spray chamber, with a paint formulated according to aspects of the present application, it is proposed herein to control the humidity in the controlled-humidity spray chamber to maintain the humidity below 30% Relative Humidity. By controlling the humidity in this manner, the paint formulated according to aspects of the present application is permitted to stay wet and receive overspray that blends in. Such blending may be understood to allow the finish to be smooth and free of dry spray.

When painting a relatively small object, in a controlled-humidity spray chamber, with a paint formulated according to aspects of the present application, it is proposed herein to, again, control the humidity in the controlled-humidity spray chamber. However, in contrast to the 30% limit proposed for relatively large objects, in the relatively small object case, humidity may be allowed to increase as high as 85% Relative Humidity.

According to Marc Broekaert, “Polyurea spray coatings, The technology and latest developments,” Huntsman International LLC Publication, 2002, current, 100% non-volatile polyurea polyaspartic paints cure very quickly. The cure time for these paints is known to range from 5 seconds to 20 minutes.

In a controlled-humidity curing chamber, the cure time for a paint formulated according to aspects of the present application may be controlled to range between 15 minutes and 10 hours. Such control over the cure time may be accomplished through control of the level of relative humidity in the controlled-humidity curing chamber.

The moisture in Component A can also be controlled for dual curing, internal and external of the controlled-humidity curing chamber.

Dual curing may involve measuring moisture in the Component A side using a Karl Fischer moisture meter. Some of the molecular sieve may then be added and a ratio may be determined to hold the moisture from reacting. This allows us to shorten the dry time with some moisture remaining in the Component A side.

The more moisture in the Component A side, the shorter the pot life and the faster a paint formulated according to aspects of the present application will dry external to the controlled-humidity curing chamber.

In this case, there is some moisture in the Component A side predetermined for dry time at a specific humidity.

Subsequently, the external humidity may be controlled for curing within the controlled-humidity curing chamber.

As will be generally understood, a spray chamber may be located in an area with a climate that provides for an atmospheric humidity that is already in a range that is desireable for a particular application of a paint formulated according to aspects of the present application.

However, aspects of the present application make use of a spray chamber and a curing chamber that both include means for raising and lowering (i.e., controlling) humidity. Aspects of the present application also make use of a spray chamber and a curing chamber that both include means for raising and lowering (i.e., controlling) temperature. For example structures with these means, see Sacramento Municipal Utility District, Humidity Control, Online solutions for the Energy Industry, 2015.

For curing, it is preferred to maintain the humidity above 30% relative humidity up to 100%. Cure times can be controlled to have a duration as low as 20 minutes at higher humidity values. Also, air circulation in the curing chamber is important. Proper air circulation may be shown to introduce moisture laden air to a painted surface in the curing chamber on a continuous basis. Proper air circulation may be defined as about 100 lineal feet per minute past the part up to about 400 lineal feet per minute.

A paint formulated according to aspects of the present application may be employed even without a humidity controlled spray chamber and a humidity controlled curing chamber, due to the low viscosity and long gel time qualities of the paint formulated according to aspects of the present application.

Known high viscosity, 100% non-volatile polyurea polyaspartic paints may be shown to have difficulty achieving an “orange-peel-free” surface at the thickness of 1 mil (a mil is a thousandth of an inch). Such known polyurea polyaspartic paints normally have a limit of 8 mils on the horizontal, see Sherwin Williams Company, “Protective & Marine Coatings, Envirolastic PA Polyaspartic”, Application Bulletin”, January 2015.

A paint formed according to aspects of the present application, partially due to the long gel time and partially due to the low viscosity, is able to have a sprayed finish as low as 1 mil and can be smooth. The invention can be sprayed through airmix airless spraying equipment at 1,500 psi using a nozzle with a 413 tip size.

In tip size numbers, such as “413,” the first number in the set of three numbers is the spray pattern size. The first number is representative of half of the spray pattern height, in inches. So if the first number is a 5, then the pattern will be 10 inches tall when sprayed at a predetermined distance from the surface. The second two numbers in the set of three is representative of an orifice size, in thousandths of an inch. The numbers 13, 15 and 17 are representative of orifice sizes of 0.013 inches, 0.015 inches and 0.017 inches, respectively. The orifice size is a known factor in controlling the amount of paint coming out of a spray gun to which the nozzle is attached.

Consider a case wherein a paint formulated according to aspects of the present application is left overnight in a hose of a spray system. If moisture in the paint has been controlled to be low, the paint is likely to be liquid enough, at the end of the overnight, to flush out of the system. That is, the next day, the paint is unlikely to have turned to a solid. A paint turning to a solid within a spray system is known to irreparably damage the hose and the spray gun.

Industrial, high quality coatings normally use heat for the curing stage.

Such industrial, high quality coatings include powder coatings, polyurethane coatings and Non-ISOcyanate (NISO) coatings.

Powder coatings are 100% solid powder. When applying powder coatings, in particular, to an object composed of metal or other substrates, there exists a need for the temperature of the object to exceed a threshold temperature (e.g., 270° F.). Additionally, there exists a need for the temperature of the object to remain in excess of the threshold temperature for a duration of 30 minutes or more. In some cases, such as larger objects, the threshold temperature may be 400° F. and the duration may exceed an hour (See, for example, Zeno W. Wicks, Jr., Frank N. Jones, S. Peter Pappas, Douglas A. Wicks, “Organic Coatings Science And Technology”, 3rd Edition, January 2007).

It should be clear that such object heating and temperature maintenance requires energy input.

In a production setting, it is typical that a film of a polyurethane, two component coating or a film of a NISO coating will be subject to a “flash off stage,” which is associated with a time duration called a “flash period.” During the flash period, a large portion of the solvents in the coating will leave the film. The solvents may, in one example, be emitted into the atmosphere. Alternatively, the solvents may, in another example, be incinerated. Subsequent to the flash off stage, the coated objects may be subject to heating in a batch oven or in a conveyorized oven. The heating duration, that is, the duration that the coated objects spend in the selected oven may, for example, range from 10 minutes to 40 minutes. The temperature of the selected oven may, for example, range from 120° F. to 280° F. Subjecting the coated objects to time in a warm oven may be called a “force dry.” Subsequent to their time in the selected oven, the coated objects are allowed some cooling time. The cooling duration, that is, the duration that the coated objects spend cooling before the coated objects are handled, is often set as half of the heating duration.

Conveniently, a paint formulated according to aspects of the present application does not require a flash off stage. That is, a paint formulated according to aspects of the present application does not need full exhaust in the spray chamber or in the curing chamber. Furthermore, on objected coated with a paint formulated according to aspects of the present application does not require a cooling duration. Instead, the object may be worked on immediately after leaving the curing chamber.

For a particular dry film thickness, it may be readily illustrated that a paint formulated according to aspects of the present application may be applied in an application time that is close to half of an application time for known solvent-laden polyurethane coatings and hybrid polyurethane/polyaspartic coatings. The reduced application time may be considered to be due to the solids content of the paint formulated according to aspects of the present application.

Conveniently, a paint formed according to aspects of the present application may be custom designed for application open time. The term “open time” is well known from American Society for Testing Materials (ASTM) D7488—“Test Method For Open Time On Latex Paints.”

Conveniently, aspects of the present application relate to a paint that has a usable “pot life” and sprayability through current equipment.

Aspects of the present application relate to a paint that cures from a wet stage to a dry stage in under two hours when painted at 5 mil or less wet.

Aspects of the present application relate to a paint that dries to a pencil hardness of greater than 4 HB. Thicker films take longer or may be softer after curing for two hours.

Conveniently, for a paint formed according to aspects of the present application, a flash off stage is not required. This is due to solvent not being present in the paint. Aspects of the present application relate to a paint that exhibits a viscosity that obviates any need for solvents.

Aspects of the present application relate to coating systems that are plural component and that cure in the presence of moisture.

The material will be capable of passing, using conventional fluid pressure, through conventional airless sprayers, air mix airless sprayers, high volume low pressure (HVLP) sprayers, siphon sprayers and pressure pot sprayers.

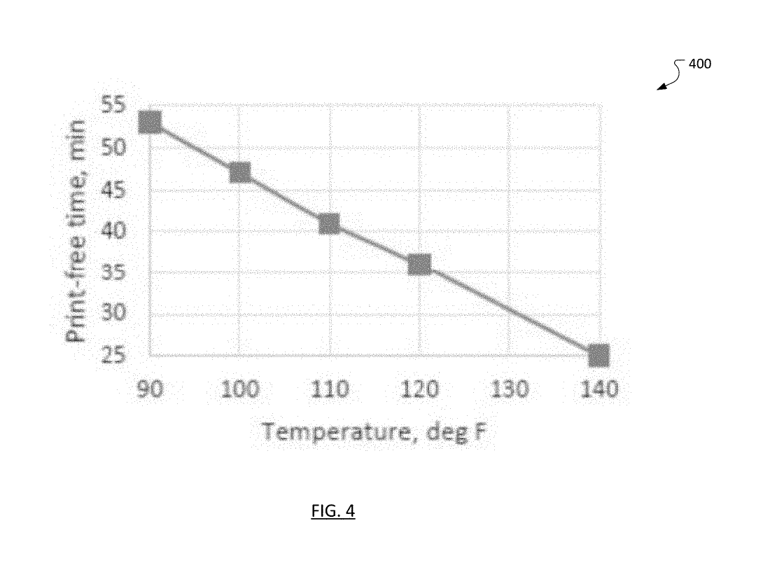

FIG. 4 illustrates a plot relating Print-free time to temperature for experiments carried out on a paint according to aspects of the present application.

The above-described implementations of the present application are intended to be examples only. Alterations, modifications and variations may be effected to the particular implementations by those skilled in the art without departing from the scope of the application, which is defined by the claims appended hereto.

What is claimed is:

1. A paint formed by mixing a first component with a second component,
the first component comprising:
an amine-functional aspartic acid ester;
an cycloaliphatic diamine;
propylene carbonate; and
a molecular sieve;
the second component comprising an hexamethylene diisocyanate trimer polyisocyante.

2. The paint of claim 1, wherein the hexamethylene diisocyanate comprises Desmodur® N 3900.

3. The paint of claim 1, wherein the amine-functional aspartic acid ester comprises DESMOPHEN® NH 1420.

4. The paint of claim 1, wherein the amine-functional aspartic acid ester comprises about 47.10 percent, by weight, of the first component.

5. The paint of claim 1, wherein the cycloaliphatic diamine comprises VESTAMIN A 139.

6. The paint of claim 1, wherein the cycloaliphatic diamine comprises about 12.0 percent, by weight, of the first component.

7. The paint of claim 1, wherein the propylene carbonate comprises JEFFSOL® PC.

8. The paint of claim 1, wherein the propylene carbonate comprises about 13 percent, by weight, of the first component.

9. The paint of claim 1, further comprising a dispersing agent.

10. The paint of claim 9, wherein the dispersing agent comprises DISPERBYK-2155.

11. The paint of claim 9, wherein the dispersing agent comprises about 0.8 percent, by weight, of the first component.

12. The paint of claim 1, wherein the molecular sieve comprises SYLOSIV® 3A.

13. The paint of claim 1, wherein the molecular sieve comprises about 3.0 percent, by weight, of the first component.

14. The paint of claim 1, further comprising an ultra-violet light absorber of the hydroxyphenylbenzotriazole class.

15. The paint of claim 14, wherein the ultra-violet light absorber of the hydroxyphenylbenzotriazole class comprises Tinuvin® 292.

16. The paint of claim 14, wherein the ultra-violet light absorber of the hydroxyphenylbenzotriazole class comprises about 1.1 percent, by weight, of the first component.

17. The paint of claim 1, further comprising a mono-oxazolidine.

18. The paint of claim 17, wherein the mono-oxazolidine comprises Incozol® 2.

19. The paint of claim 17, wherein the mono-oxazolidine comprises about 5.4 percent, by weight, of the first component.

20. The paint of claim 1, further comprising a micronised amide wax rheology modifier.

21. The paint of claim 20, wherein the micronised amide wax rheology modifier comprises CRAYVALLAC® SUPER.

22. The paint of claim 20, wherein the micronised amide wax rheology modifier comprises about 1 percent, by weight, of the first component.

23. The paint of claim 1, further comprising titanium dioxide.

24. The paint of claim 23, wherein the titanium dioxide comprises TRONOX® CR-826.

25. The paint of claim 23, wherein the titanium dioxide comprises about 18.3 percent, by weight, of the first component.

26. The paint of claim 1, wherein the paint has viscosity of less than 120 Kreb units at 20° C.

27. The paint of claim 1, wherein about 54.2 grams of the second component for every 100 grams of the first component.

28. A method of forming a paint comprising mixing a first component with a second component,
the first component including:
an amine-functional aspartic acid ester;
an cycloaliphatic diamine;
propylene carbonate; and
a molecular sieve;
the second component including a hexamethylene diisocyanate trimer polyisocyante.

29. A method of painting an object, the method comprising:
mixing a first component with a second component to form a paint;
controlling a humidity in a spray chamber while applying the paint to the object in the spray chamber; and
controlling a humidity in a curing chamber while allowing the paint to cure on the object in the curing chamber;
the first component including:
an amine-functional aspartic acid ester;
an cycloaliphatic diamine;
propylene carbonate; and
a molecular sieve;
the second component including a hexamethylene diisocyanate trimer polyisocyante.

30. The method of claim 29 wherein controlling the humidity in the spray chamber comprises maintaining the relative humidity below 30%.

31. The method of claim 29 wherein controlling the humidity in the curing chamber comprises maintaining the relative humidity above 30%.
